(19) United States
(12) Patent Application Publication
(10) Pub. No.: US 2025/0182404 A1
(43) Pub. Date: Jun. 5, 2025

(54) FOUR-DIMENSIONAL OBJECT AND SCENE MODEL SYNTHESIS USING GENERATIVE MODELS

(71) Applicant: NVIDIA Corporation, Santa Clara, CA (US)

(72) Inventors: Karsten Julian KREIS, Vancouver (CA); Seung Wook KIM, Toronto (CA); Huan LING, Toronto (CA); Sanja FIDLER, Toronto (CA)

(73) Assignee: NVIDIA Corporation, Santa Clara, CA (US)

(21) Appl. No.: 18/422,634

(22) Filed: Jan. 25, 2024

Related U.S. Application Data
(60) Provisional application No. 63/606,193, filed on Dec. 5, 2023.

(51) Int. Cl. G06T 19/00; G06T 13/20

(52) U.S. Cl. CPC G06T 19/00; G06T 13/20; G06T 2210/56

(57) ABSTRACT

In various examples, systems and methods are disclosed relating to generation of four-dimensional (4D) content models, such as 4D content models to render realistic sequences of frames of 3D data. The systems can initialize a 3D component of the 4D content model, such as a 3D Gaussian splatting representation, based at least on a prompt for the 4D content. The system can configure motion and/or dynamics for the sequence of frames by evaluating frames rendered from the 4D content model using one or more latent diffusion models (LDMs), including a video LDM. The system can perform operations such as autoregressive generation of frames to create long sequences of content, motion amplification to facilitate realistic, dynamic motion generation, and regularization to facilitate generation of complex dynamics.

### CROSS-REFERENCE TO RELATED APPLICATIONS

The present application claims the benefit of and priority to U.S. Provisional Application No. 63/606,193, filed Dec. 5, 2023, the disclosure of which is incorporated herein by reference in its entirety.

### BACKGROUND

Machine learning models, such as neural networks, can be used to represent environments or scenes. For example, image and/or video data of some portions of the environments can be used to interpolate or otherwise determine more complete representations of environments. However, it can be difficult to generate more complex representations of the scene without significant input direction and/or computational resources in a manner that provides realism and consistency across space, orientation, and/or time.

### SUMMARY

Embodiments of the present disclosure relate to synthetic four-dimensional object and scene models based on inputs including textual inputs. In contrast to conventional systems, such as those described above, systems and methods in accordance with the present disclosure can allow for realistic four-dimensional (4D) content to be generated from textual inputs, such as to represent at least one of an object or a scene with three-dimensional (3D) data (e.g., having three spatial dimensions) and over time. For example, systems and methods in accordance with the present disclosure can generate 4D video content that can have diversity (e.g., greater information and/or variation relative to the input), avoid saturated, blurry outputs, and/or have global geometric consistency.

At least one aspect relates to a processor. The processor can include one or more circuits that can be used to receive an input indicating one or more features of content, the content including at least one of an object or a scene. The one or more circuits can initialize a content model, according to the input, to represent the input in three spatial dimensions and a time dimension. The one or more circuits can update the content model by rendering one or more sequences of frames from the content model, determining, using a latent diffusion model, a metric of the one or more sequences, and modifying the content model according to the metric, until a convergence condition is satisfied. The one or more circuits can cause at least one of (i) a simulation to be performed using the updated content model or (ii) presentation of the updated content model using a display.

In some implementations, the latent diffusion model includes one or more layers configured for the time dimension. The latent diffusion model can include or be coupled with an optimizer configured to determine the metric based at least on a gradient associated with a given frame of the one or more sequences of frames. In some implementations, the content model is conditioned on camera movements relating to the three spatial dimensions and a time value relating to the time dimension, and the one or more circuits can render a given sequence of frames of the one or more sequences of frames according to a given camera pose for the given sequence of frames and provide the given sequence of frames as input to the latent diffusion model.

In some implementations, the one or more circuits can update the content model according to a predetermined input identifying a camera pose for the given sequence of frames and a time point for one or more frames of the given sequence of frames. The one or more circuits can determine the metric according to the given sequence of frames rendered according to the predetermined input.

In some implementations, the content model includes a deformation field, and can include at least one of a Gaussian splatting representation, a neural radiance field (NeRF), a mesh representation, or a point cloud. In some implementations, the one or more circuits are configured to update the content model according to a physics model configured to measure (e.g., parameterize) a physics-based realism of motion represented in the one or more sequences of frames. In some implementations, the one or more circuits can render, from the updated content model, a first frame for a first time point and a second frame for a second time point subsequent to the first time point, modify the updated content model according to the second frame, and render, from the modified content model, a third frame for a third time point subsequent to the second time point according to the second frame.

In some implementations, the one or more circuits are to update the content model according to a physics model configured to measure a physics-based realism of motion represented in the one or more sequences of frames. In some implementations, the one or more circuits are to identify, from the updated content model, at least one of a joint of an object represented by the updated content model, a movement property of the object, or a deformation property of the object.

At least one aspect relates to a system. The system can include one or more processing units to execute operations including receiving an input indicating one or more features of content, the content comprising at least one of an object or a scene. The one or more processing units can initialize a content model, according to the input, to represent the input in three spatial dimensions and a time dimension. The one or more processing units can update the content model by: rendering one or more sequences of frames from the content model, determining, using a latent diffusion model, a metric of the one or more sequences, and modifying the content model according to the metric, until a convergence condition is satisfied. The one or more processing units can cause at least one of (i) a simulation to be performed using the updated content model or (ii) presentation of the updated content model using a display.

In some implementations, the latent diffusion model includes one or more layers configured for the time dimension. The latent diffusion model can include or be coupled with an optimizer configured to determine the metric based at least on a gradient associated with a given frame of the one or more sequences of frames. In some implementations, the content model is conditioned on camera movements relating to the three spatial dimensions and a time point relating to the time dimension, and the one or more circuits can render a given sequence of frames of the one or more sequences of frames according to a given camera pose for the given sequence of frames and provide the given sequence of frames as input to the latent diffusion model.

In some implementations, the one or more processing units can update the content model according to a predetermined input identifying a camera pose for the given sequence of frames and a time point for one or more frames of the given sequence of frames. The one or more processing units can determine the metric according to the given sequence of frames rendered according to the predetermined input.

In some implementations, the content model includes a deformation field, and can include at least one of a Gaussian splatting (e.g., Gaussian Splat) representation, a neural radiance field (NeRF), a mesh representation, or a point cloud. In some implementations, the one or more processing units can update the content model according to a physics model configured to measure a physics-based realism of motion represented in the one or more sequences of frames. In some implementations, the one or more processing units can render, from the updated content model, a first frame for a first time point and a second frame for a second time point subsequent to the first time point, modify the updated content model according to the second frame, and render, from the modified content model, a third frame for a third time point subsequent to the second time point according to the second frame.

In some implementations, the one or more processing units are to update the content model according to a physics model configured to measure a physics-based realism of motion represented in the one or more sequences of frames. In some implementations, the one or more processing units are to identify, from the updated content model, at least one of a joint of an object represented by the updated content model, a movement property of the object, or a deformation property of the object.

At least one aspect relates to a method. The method can include receiving, by one or more processors, an input indicative of at least one of an object or a scene. The method can include initializing, by the one or more processors, based at least on the input, a plurality of spatial dimensions of a content model of the at least one of the object or the scene. The method can include updating, by the one or more processors, the content model to have a temporal dimension responsive to evaluating a plurality of frames rendered from the content model at a plurality of points in time using a latent diffusion model having one or more temporal layers, to generate an updated content model. The method can include outputting, by the one or more processors, one or more frames from the updated content model.

In some implementations, the content model includes a 3D Gaussian splatting representation corresponding to the plurality of spatial dimensions coupled with a multilayer perceptron (MLP) corresponding to the temporal dimension. In some implementations, the latent diffusion model includes one or more layers configured for the time dimension. The latent diffusion model can include or be coupled with an optimizer configured to determine the metric based at least on a gradient associated with a given frame of the one or more sequences of frames. In some implementations, the latent diffusion model is conditioned on camera movements relating to the three spatial dimensions, and the one or more circuits can render a given sequence of frames of the one or more sequences of frames according to a given camera pose for the given sequence of frames.

In some implementations, the method includes rendering a given sequence of frames of the one or more sequences of frames according to a predetermined input identifying a camera pose for the given sequence of frames. The method can include determining the metric according to the given sequence of frames rendered according to the predetermined input.

In some implementations, the method includes updating the content model according to a physics model. The physics model can measure a physics-based realism of motion represented in the one or more sequences of frames. In some implementations, the method includes rendering, from the updated content model, a first frame for a first time point and a second frame for a second time point subsequent to the first time point, modifying the updated content model according to the second frame, and rendering, from the modified content model, a third frame for a third time point subsequent to the second time point according to the second frame.

The processors, systems, and/or methods described herein can be implemented by or included in at least one of a system for generating synthetic data; a system for performing simulation operations; a system for performing conversational AI operations; a system for performing collaborative content creation for 3D assets; a system that includes one or more language models, such as large language models (LLMs); a system for generating or presenting virtual reality (VR) content, augmented reality (AR) content, and/or mixed reality (MR) content; a system for performing digital twin operations; a system for performing light transport simulation; a system for performing deep learning operations; a system implemented using an edge device; a system implemented using a robot; a system associated with an autonomous or semi-autonomous machine (e.g., an in-vehicle infotainment system); a system incorporating one or more virtual machines (VMs); a system implemented at least partially in a data center; or a system implemented at least partially using cloud computing resources.

### BRIEF DESCRIPTION OF THE DRAWINGS

The present systems and methods for machine learning models for synthetic image generation for supplementing neural field representations are described in detail below with reference to the attached drawing figures, wherein:

FIG. 1 is a block diagram of an example system for generation of 4D content, in accordance with some embodiments of the present disclosure;

FIG. 2 is a block diagram of an example system for generating dynamics for 4D content, in accordance with some embodiments of the present disclosure;

FIG. 3 is a flow diagram of an example of a method for generating 4D content, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to synthetic four-dimensional (4D) object and/or scene models that can be generated/established/configured based on textual inputs for instance, such as to synthesize 4D dynamic image data structures (e.g., Gaussian splatting representations or neural radiance fields) from high resolution text-to-video diffusion models. For example, systems and methods in accordance with the present disclosure can allow for a language-based input, such as text, speech, and/or audio indicating one or more features of an object or scene, to be processed by the model to generate a three-dimensional (3D) video, such as to provide 4D content representing the one or more features. In some implementations, systems and methods in accordance with the present disclosure can provide the 4D content in the form of a 3D representation (e.g., 3D Gaussian splatting) coupled with a deformation field (e.g., multilayer perceptron (MLP)-based deformation field).

Various machine learning models, such as diffusion models, can be used to generate image data based on text inputs. For example, diffusion models, configured (e.g., pre-trained) using training data that includes text mapped to images, can be used to generate two-dimensional (2D) images from text inputs. While some 4D systems have been developed, these systems are prone to generating data with little diversity, as well as data lacking image quality (e.g., overly saturated, blurry outputs); this can result from the use of large classifier-free guidance weights in the diffusion model underlying these systems. Such systems can also have geometrically inconsistent results, such as by not having direct 3D knowledge or awareness (e.g., by independently rendering different views of the 3D object). Some systems can also operate in pixel space, limiting the resolution available to operate on and/or requiring significant computational resources.

Systems and methods in accordance with the present disclosure can implement a 4D content generation system (e.g., three image dimensions plus time) to generate video content from text inputs. A system can include a content data structure (e.g., content model) and a latent diffusion model (LDM). The content model can be structured to represent 4D content, such as to include 4D representations of objects and/or scenes. For example, the content model can have dimensions [x, y, z, t] corresponding to three spatial dimensions and a temporal dimension. The content data structure can be, for example, an object model or scene model, such as a neural radiance field (NeRF), an implicit function (e.g., a multilayer perceptron (MLP) neural network), a grid-based representation, a point-based representation (e.g., point cloud), a 3D Gaussian splatting representation, hexplanes, mesh representations, triplanes extended with a temporal component or deformation field, or various combinations thereof.

The LDM can perform functions including at least one of text-to-image, text-to-video (e.g., two spatial dimensions plus time), or text-to-3D data generation. For example, the LDM can include one or be coupled with one or more machine learning models, including large scale models such as 2D text-to-image models; large scale text-to-video (video LDM); 3D diffusion models (which can be used to ensure each frame of a 4D sequence is 3D consistent), or various combinations thereof. The LDM(s) can be configured by fine-tuning and/or transfer learning of one or more temporal layers that are added to a text-to-image LDM. By using the LDM, high resolution renderings (e.g., from the content model) can be provided to the LDM for processing, which can avoid issues with image quality and/or avoid the need for a separate super-resolution model.

The LDM can be used to evaluate (e.g., score) one or more rendered frame sequences from the content data structure in order to update and/or optimize the content model and thus the 4D sequences that can be generated from the content model. For example, the LDM can be used to generate a gradient according to the evaluation that can be backpropagated for the rendering of the one or more rendered frame sequences. The evaluation and backpropagation can be performed, for example, using an optimizer/scoring technique such as score distillation sampling (SDS) or variational score distillation (VSD); using VSD can be useful to improve the diversity of outputs, and can reduce the likelihood of outputs being generated that are blurry or over-saturated. Video data, such as one or more frames of a video, can be used to initialize the content model.

The LDM (e.g., text-to-video LDM) can be fine-tuned to be conditioned on camera pose and/or movements. This can mitigate geometric inconsistencies with how the 3D features are added to the content. The optimization (e.g., using VSD) can use conditioning related to camera pose (e.g., informing the model of a pose, such as “side view”), and can compare score function determinations with and without the conditioning to account for view conditioning. This can allow classifier-free guidance weights to be reduced, overcoming issues with image blurriness, low diversity, and/or oversaturation.

The system can be used to generate long 4D sequences, e.g., having many frames (long with respect to time dimension). For example, an end frame of a first sequence can be used for input conditioning of a second sequence. These operations can be performed in an autoregressive manner to generate 4D sequences of arbitrary length.

Customization or personalization can be performed by fine-tuning the LDM using one or more images, such as images of objects and/or scenes to be represented using the content model. Physics models can be used in the system to facilitate generating realistic movements. 3D assets such as joints, motion profiles, or other information regarding how 3D objects in the 4D representation may move can be extracted from the content model.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implementing one or more language models, such as LLMs, systems implemented at least partially in a data center, systems for performing conversational AI operations, systems for performing light transport simulation, systems for performing collaborative content creation for 3D assets, systems implemented at least partially using cloud computing resources, and/or other types of systems.

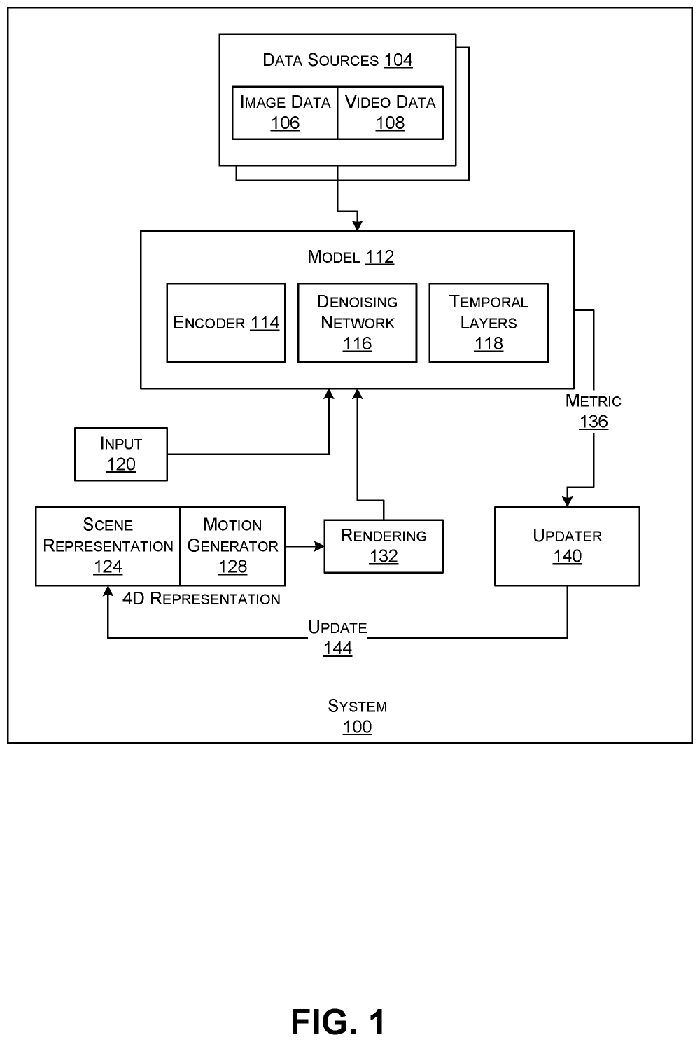

With reference to FIG. 1, FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine learning model), operation, routine, logic, or instructions to perform functions such as configuring diffusion model 112, scene representation 124, and/or motion generator 128 as described herein, such as to configure machine learning models to operate as diffusion models.

The system 100 can include or be coupled with one or more data sources 104. The data sources 104 can include any of various databases, data sets, or data repositories, for example. The data sources 104 can include data to be used for configuring any of various machine learning models (e.g., models 112; scene representation 124). The one or more data sources 104 can be maintained by one or more entities, which may be entities that maintain the system 100 or may be separate from entities that maintain the system 100. In some implementations, the system 100 uses data from different data sets, such as by using data from a first data source 104 to perform at least a first configuring (e.g., updating or training) of the models 112, and uses training data elements from a second data source 104 to perform at least a second configuring of the models 112. For example, the first data source 104 can include publicly available data, while the second data source 104 can include domain-specific data (which may be limited in access as compared with the data of the first data source 104). The data 108 can include data from any suitable image dataset including labeled and/or unlabeled image data. In some examples, the data sources 104 include data from large-scale image datasets (e.g., ImageNet) that are available from various sources and services.

The data sources 104 can include, without limitation, data 108 such as any one or more of text, speech, audio, image, and/or video data. The system 100 can perform various pre-processing operations on the data, such as filtering, normalizing, compression, decompression, upscaling or downscaling, cropping, and/or conversion to grayscale (e.g., from image and/or video data). Images (including video) of the data 108 can correspond one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data 108 can include videos and/or video data structured as a plurality of frames (e.g., image frames, video frames), such as in a sequence of frames, where each frame is assigned a time index (e.g., time step, time point) and has image data assigned to one or more pixels of the images.

In some implementations, the image data and/or video data of the data 108 include camera pose information. The camera pose information can indicate a point of view by which the data 108 is represented. For example, the camera pose information can indicate at least one of a position or an orientation of a camera (e.g., real or virtual camera) by which the data 108 is captured or represented.

The system 100 can train, update, or configure one or more models 112 (e.g., machine learning models). The machine learning models 112 can include machine learning models or other models that can generate target outputs based on various types of inputs. The machine learning models 112 may include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating candidate outputs of the neural network.

The models 112 can be or include various neural network models, including models that are effective for operating on or generating data including but not limited to image data, video data, text data, speech data, audio data, or various combinations thereof. The machine learning models 112 can include one or more transformers, recurrent neural networks (RNNs), long short-term memory (LSTM) models, other network types, or various combinations thereof. The machine learning models 112 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

The models 112 can include at least one diffusion model 112. The diffusion model can include a network, such as a denoising network 116. For example, in brief overview, the diffusion model can include a denoising network 116 that is configured (e.g., pre-trained, trained, updated, fine-tuned, and/or has transfer learning applied) using training data of the data 108 that includes data elements to which noise is applied, and configuring the denoising network 116 to modify the noise-augmented data elements to recover the (un-noised) data elements.

The model 112 can include (e.g., the denoising network 116 can be implemented as) a latent diffusion model (LDM). The LDM can include or be coupled with an encoder 114. The encoder 114 can include a neural network to encode (e.g., compress) data to a lower dimensional, compressed latent space (e.g., latent tensors, latent representations, latent encoding), such as to allow operations to be performed more efficiently in the latent space. For example, this can allow the model 112 to receive high-resolution image and/or video data for configuring the model 112 while maintaining target performance levels. For example, the encoder 114 can allow the model 112 to improve the computational and memory efficiency over pixel-space Diffusion Models (DMs) by first training the encoder 114 to transform input images (e.g., of data 108) into a spatially lower-dimensional latent space of reduced complexity, from which the original data can be reconstructed at high fidelity. This approach can be implemented with a regularized autoencoder, which reconstructs input images and a decoder (e.g., a decoder neural network). The latent space can be smaller in terms of parameter count and/or memory consumption by the model 112 to operate in the latent space as compared to corresponding pixel-space DMs of similar performance.

The model 112 can include, as (part of) the LDM, the denoising network 116, which can be coupled with the encoder 114, such as to perform operations on data mapped to the latent space by the encoder 114. The system 100 can configure the denoising network 116 by causing the denoising network 116 to reproduce example data to which noise has been applied. In some implementations, the system 100 configures the denoising network 116 by conditioning the denoising network 116 according to conditioning inputs (e.g., text inputs), allowing the denoising network 116 to generate outputs responsive to receiving inputs (e.g., at runtime/inference time).

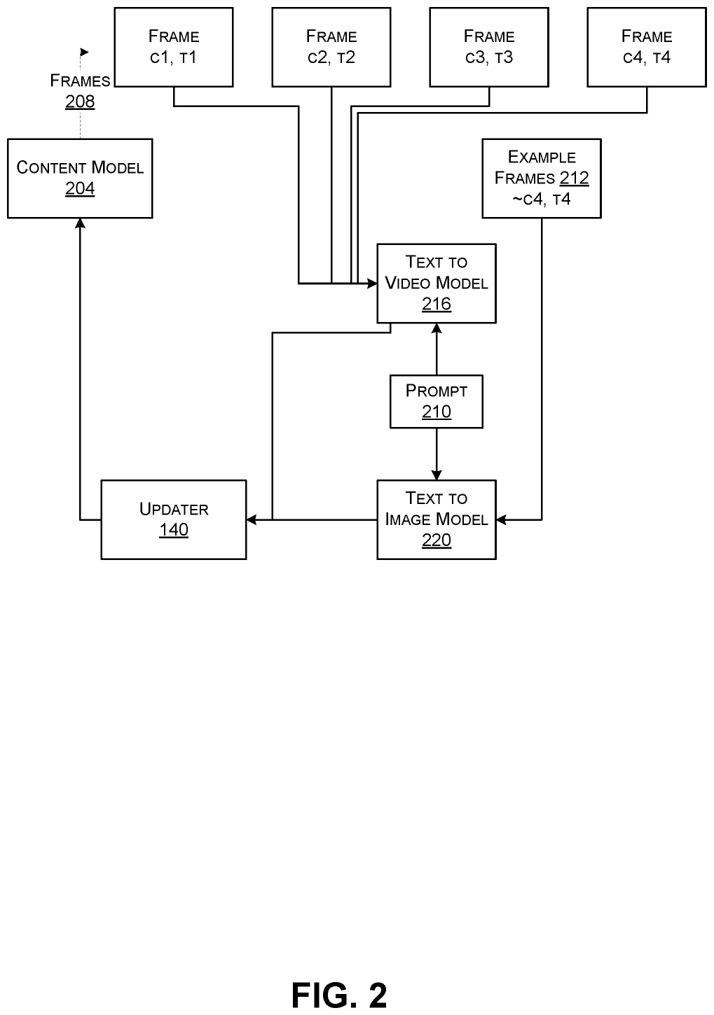

For example, the system 100 can perform diffusion on one or more images x₀ (and/or image frames of video) of the data 108. The system 100 can perform diffusion by applying noise to (e.g., diffusing) the data 108, to determine training data points (e.g., diffused or noised data, such as noised images x_{T}, such as described as diffused frames with reference to FIG. 2). For example, the system 100 can add the noise to the data 108 (e.g., add a numerical value representing the noise in a same data format as the data 108, to the data 108) to determine the training data points. The system 100 can determine the noise to add to the data 108 using one or more noise distributions, which may indicate a noise level according to a time t, where 0<t<T, such that applying noise corresponding to the time T may result in the training data point x_{T} representing Gaussian noise. For example, the noise can be a sample of a distribution, such as a Gaussian distribution. The system 100 can apply the noise according to or with respect to a duration of time t. The duration of time t can be a value in a time interval, such as a value between zero and a maximum T of the time interval. The duration of time t may be a multiple of a number of discrete time steps between zero and T. The maximum T may correspond to an amount of time such that the result of applying noise for a duration of time T may be indistinguishable or almost indistinguishable from Gaussian noise. For example, the system 100 can apply diffusion to the image x₀ for the duration T to determine the training data point (e.g., noised image) x_{T}.

Referring further to FIG. 1, the denoising network 116 can be implemented, for example and without limitation, using a U-Net, such as a convolutional neural network that includes downscaling and upscaling paths. The denoising network 116 can receive the training data point x_{T} and determine an estimated output responsive to receiving the training data point x_{T}. The estimated output can have a same format as the training data point x_{T}, such as to be an image having a same number of rows of pixels and columns of pixels as the training data point x_{T} (and/or as data 108 compressed by the encoder 114, such as where the denoising network 116 generates the estimated output and provides the estimated output to a decoder network for decoding up to the format of the data 108).

In some implementations, the system 100 can cause the model 112 (e.g., LDM as implemented by the denoising network 116) to learn to model the data distribution x via iterative denoising using the denoising network 116, and can be trained (e.g., updated) with denoising score matching. A noise schedule can be parameterized via a diffusion time over which logarithmic signal-to-noise ratio monotonically decreases. A denoiser model can receive the diffused inputs that are parameterized with learnable parameters and can optimize a denoising score matching objective based on conditioning information (e.g., text prompt), target vector (e.g., random noise), forward diffusion process, reverse generation process, and so on. The input images x can be perturbed into a Gaussian random noise over a maximum diffusion time (e.g., time 7). An iterative generative denoising process that employs the learned denoiser (e.g., the denoising neural network 116) can be initialized from the Gaussian noise to synthesize novel data.

Referring further to FIG. 1, the system 100 can configure the model 112 to be or include a video diffusion model, such as a video LDM. For example, the system 100 can configure the model 112 (e.g., the denoising network 116) to include or be coupled with at least one temporal layer 118. This can allow the denoising network 116 (e.g., together with temporal layer(s) 118) to generate outputs having image data (e.g., in two or three spatial dimensions) over time (e.g., based on operation of the at least one temporal layer 118). The temporal layer 118 can be, for example, one or more neural network layers, such as an attention neural network layer.

The system 100 can configure the temporal layer 118 using video data of the data 108, such as one or more sequence of frames of video retrieved from the data 108. For example, the system 100 can update/train the temporal layer 118 (e.g., independently from or together with the denoising network 116) to align multiple images generated by the denoising network 116 into frames of a video, by, for example, aligning multiple images generated by the denoising network 116 into consecutive frames of the video, referred to as the first video. The first video can be an initial low-temporal-resolution (or low frame rate, low FPS) video and low-spatial-resolution video (referred to as the first video) that is up-sampled in the manner described herein.

The system 100 can train or update the at least one temporal layer 118 by modifying or updating one or more parameters, such as weights and/or biases, of various nodes of the neural network responsive to evaluating candidate outputs of the at least one temporal layer 118. The output of the at least one temporal layer 118 can be used to evaluate whether the at least one temporal layer 118 has been trained/updated sufficiently to satisfy a target performance metric, such as a metric indicative of accuracy of the at least one temporal layer 118 in generating outputs. Such evaluation can be performed based on various types of loss. For example, the system 100 can use a function such as a loss function to evaluate a condition for determining whether the at least one temporal layer 118 is configured (sufficiently) to meet the target performance metric. The condition can be a convergence condition, such as a condition that is satisfied responsive to factors such as an output of the function meeting the target performance metric or threshold, a number of training iterations, training of the at least one temporal attention neural network layer 118 converging, or various combinations thereof.

As discussed, the encoder 114 can map an input image (e.g., the image data 106) from an image or pixel space to a lower dimensional, compressed latent space (e.g., latent tensors, latent representations, latent encoding, and so on) where the denoising network 116 can be updated or trained more efficiently in terms of power consumption, memory consumption, and/or time. The decoder (not shown) can map the latent encoding back to the image space. The model 112 (e.g., video LDM including the denoising network 116 and temporal layers 118), fine-tuned from the image diffusion model, can model/generate/develop an increased number of video frames at the same time given fixed memory budget as compared to operating in image or pixel space directly, thus facilitating long-term video generation.

In some implementations, the temporal layer 118 can be updated or trained using the video data 108 in the manner described herein. In some examples, the model 112 is fine-tuned or updated using video data 108 to allow the model 112 to avoid introducing temporal incoherencies when decoding a frame sequence (e.g., multiple latent tensors, latent representations, latent encoding, and so on corresponding to multiple input images) generated from the latent space. The image data 106 and the video data 108 can be in the same domain in some examples. In some examples, the image data 106 and the video data 108 can be in different domains, or the image data 106 and the video data 108 can have a domain gap.

For example, the model 112 (e.g., video LDM) can include one or more layers configured to process image data and/or spatial data, and one or more temporal layers 118 configured for the time dimension, such as by fine-tuning a neural network that includes the denoising network 116 (having been updated/trained on image data) and the one or more temporal layers 118 as included with the denoising network 116. The system 100 can include an optimizer (e.g., included in or coupled with updater 140) to configure the model 112, such as to update one or more parameters (e.g., weights, biases) of the model 112 based at least on a gradient generated for the model 112.

The system 100 can include at least one scene representation 124. The scene representation 124 can include any data structure, image representation, function, model (e.g., neural network or other machine learning model), operation, routine, logic, or instructions to represent a scene or a portion of a scene, such as one or more objects in a scene (for example, the scene representation 124 can include an object representation, such as a 3D object model, and may or may not include additional objects or environment features relative to the object represented by the 3D object model). For example, the scene representation 124 can include two-dimensional (2D) and/or three-dimensional (3D) image data. The image data can represent a 3D environment, such as a real-world, physical, simulated, or virtual environment. The scene representation 124 can be a data structure that can be queried according to a direction (e.g., a vector representing a direction) and output an image according to the query, such as to output an image that includes image data representing a view of the scene as would be perceived along the direction. In some implementations, the scene representation 124 includes at least one machine learning model (e.g., a neural network, such as a neural radiance field as described herein), which can be used to generate an image data structure as a representation of the scene, object(s), and/or environment. For example, the image data structure can be a data structure that can be queried to retrieve one or more 2D or 3D portions of the representation, such as to retrieve outputs of pixels of the representation. The scene representation 124 can be generated and/or updated using at least one of real or synthetic image data, such as image data captured using image capture devices in a physical/real-world environment, or synthetic image data generated to represent virtual or simulated environments.

For example, the scene representation 124 can include, such as to represent 3D image data (e.g., point or particle data representing at least three spatial dimensions for an object and/or scene, such as to include depth information in addition to 2D image data), at least one 3D Gaussian, such as one or more 3D Gaussian Splats. For example, the scene representation 124 can include a plurality of N 3D Gaussians, each of the N 3D Gaussians corresponding to a point in time, each 3D Gaussian having parameters θ such as positions μᵢ, covariances Σᵢ (and/or standard deviations σᵢ), opacities ηᵢ, and/or colors lᵢ. The system 100 can render, from a given 3D Gaussian, a view (e.g., rendering 132) onto a 2D camera's image plane, to produce a 2D Gaussian having a projected means and projected covariances. The system 100 can determine a color C(p) of a given image pixel p of the rendered view according to point-based volume rendering, such as:

$$C ( p ) = {\sum }_{i = 1}^{N} {l}_{i} {α}_{i} {\prod }_{j = 1}^{i - 1} ( 1 - {α}_{j} ) ,$$

where

$${α}_{i} = {η}_{i} exp [ - \frac{1}{2} {( p - {\hat{μ}}_{i} )}^{T} {\hat{Σ}}_{i}^{- 1} ( p - {\hat{μ}}_{i} ) ] ,$$

\hat{μ}i is the projected means, \hat{Σ}ᵢ is the projected covariances, and j iterates over the Gaussians along the ray through the scene from pixel p until Gaussian i. In some implementations, to accelerate rendering, the system 100 divides the image planes into tiles and performs rendering in parallel for at least a subset of the tiles. In some implementations, the covariances are isotropic, which can facilitate the motion of the 3D representations (as caused by motion generator 128) being more expressive.

In some implementations, the scene representation 124 includes at least one neural radiance field (NeRF). The NeRF can be a neural network configured to determine (e.g., infer) any of a plurality of views of a scene, such as by being trained, configured, and/or updated using one or more images (2D or 3D) and/or video data of the scene, such as by configuring/updating the neural network to be able to output views that are consistent with the provided images and/or video (e.g., image data 106, video data 108, or other image and/or video data). For example, the NeRF can render a view according to at least one of an origin or a direction of the view. The NeRF can render at least one view having a different direction than respective directions of the images and/or video data used to configure the NeRF. In some implementations, the NeRF includes a neural network configured to generate values for the image data structure. In some implementations, the NeRF includes at least one of the neural network configured to generate the image data structure or the image data structure. The NeRF can be defined as a function ƒ_{θ}: (p,d)→(c,σ) that maps a 3D location of the scene p∈ [symbol] ³ and viewing direction d∈ [symbol] ² to a volumetric density σ∈[0,∞) and color (e.g., RGB color) c∈[0, 1]³. The system 100 can implement the NeRF as at least one neural network that includes one or more multilayer perceptrons (MLPs), such as a single, global MLP, or a plurality of local MLPs each corresponding to a local portion of the scene (e.g., based on local features arranged in a grid). The system 100 can implement the NeRF as a hash table, such as a multiresolution hash positional encoding. The system 100 can configure parameters (e.g., parameters θ) of the NeRF using a loss function. In some implementations, the scene representation 124 includes HexPlanes.

Referring further to FIG. 1, the system 100 can retrieve, from the scene representation 124 (or the image data structure corresponding to the scene representation 124), one or more renderings 132 (e.g., renders). The rendering 132 can be an image frame, such as a 2D image frame, of a given view of the 3D object(s) and/or scene(s) represented by the scene representation 124. The system 100 can receive queries to retrieve the one or more renderings 132 from the scene representation 124. For example, the system 100 can receive a query indicating at least one of a camera pose, an origin point, a direction, or a time point for the rendering 132, and can retrieve the rendering 132 from the scene representation 124 according to the query. The system 100 can retrieve the rendering 132 by causing the scene representation 124 to output the rendering 132 according to the at least one of the camera pose, the origin point, the direction, or the time point. In some implementations, as described above, for example, with respect to 3D Gaussians and/or the function ƒ of a NeRF, the scene representation 124 is or includes a rendering function g having parameters θ, which can be a differentiable function, and which the system 100 can cause to render the renderings 132.

The scene representation 124 can provide renderings 132 of multiple views having different points of view (e.g., perspectives corresponding to the at least one of the camera pose, origin point, or direction) and/or correspond to different points in time. For example, the scene representation 124 can provide or output at least a first view of the 3D scene and a second view of the 3D scene that may have different points of view and/or be representative of poses of objects in the 3D scene at different points in time.

Referring further to FIG. 1, in some implementations, the model 112 includes at least one multiview diffusion model. The multiview diffusion model can be configured to generate images (e.g., image frames) of 3D objects (e.g., 3D objects represented by scene representation 124). For example, the multiview diffusion model can be a 3D-aware text-conditioned model that can generate a view of one or more objects of the scene representation 124 responsive to receiving an indication of a given view (e.g., camera pose, origin point, or direction) for the view to be generated. In some implementations, the multiview diffusion model is configured based at least on a diffusion model, such as an image model (e.g., text-to-image model) 112, such as by fine-tuning a latent text-to-image model using 3D object data (e.g., of image data 106).

As depicted in FIG. 1, the models 112 can receive an input 120, and can generate output(s) responsive to the input 120. The input 120 can include any one or more text, speech, audio, image, and/or video input data, based at least on which the models 112 can generate outputs, such as to generate 2D image, 3D image, and/or video outputs. For example, the input 120 can represent text information such as “a dog running,” responsive to which the text-to-image model 112 can generate an image frame of a dog running, the multiview diffusion model 112 can generate multiple image frames from multiple camera views of a dog running, and the text-to-video model 112 can generate a sequence of image frames representative of a dog running (e.g., showing motion of the dog across the sequence of frames).

The system 100 can allow for personalized 4D generation, such as for personalization of the scene representation 124. For example, the system 100 can receive input comprising one or more images representative of a subject (e.g., a person, a user), and can apply the one or more images as part of the input 120 to the models 112 and/or to the scene representation 124, such as for initialization of the scene representation 124 using the one or more images.

In some implementations, the system 100 performs view guidance (e.g., camera pose-based conditioning) for generating of the scene representation 124 using the multiview diffusion model 112. For example, the system 100 can augment the input 120 with text representative of a view for one or more camera poses, such as “top view,” “front view,” “side view,” “rear view,” for example and without limitation. This can be used to amplify the effect of directional text prompt augmentation.

Referring further to FIG. 1, the scene representation 124 can include or be coupled with a motion generator 128. The scene representation 124 and motion generator 128 can together form a 4D representation (e.g., a sequence of 3D frames represented by the scene representation 124 having motion between frames as defined by the motion generator 128). The motion generator 128 can include a function that can determine a state (e.g., position, pose) of one or more objects of the scene representation 124 at a first point in time based at least on the state of the one or more objects at a second point in time prior to the first point in time. The motion generator 128 can include a deformation field Δ_{Φ}. The motion generator 128 can have parameters x, y, z, τ (e.g., three spatial dimension parameters and one time dimension parameter). For example, the deformation field can be Δ_{Φ}(x, t, y, τ) and can output (e.g., predict) a displacement (Δx, Δy, Δz) for a given 3D location (x, y, z) and time T. In some implementations, the deformation field is or includes a neural network, such as a multilayer perceptron (MLP) Φ. As described further herein with reference to operation of updater 140, the deformation field Φ can be updated by the updater 140 according to metric 136 from evaluation of renderings 132 by the model(s) 112.

In some implementations, the system 100 regularizes the deformation field, which can allow for nearby Gaussians of the scene representation 124 to deform in a similar manner. For example, the system 100 can perform the regularization by determining a 3D mean and diagonal covariance matrix of the 3D Gaussians of the scene representation at a plurality of time points r of the 4D sequence, and can modify at least one 3D Gaussian of the 3D Gaussians to reduce a difference with respect to one or more other 3D Gaussians of the 3D Gaussians, such as to regularize using Jenson-Shannon divergence. This can allow for moments of distribution of the Gaussians to be maintained as approximately constant across time, and can allow for the system 100 to generate meaningful, complex dynamics.

In some implementations, the system 100 combines a plurality of scene representations 124 and/or motion generators 128. For example, the system 100 can combine (e.g., add) a first scene representation 124 and corresponding motion generator 128 with a second scene representation 124 and corresponding motion generator 128.

In some implementations, the system 100 conditions the video LDM of the model 112 on a frame rate of the scene representation 124. For example, the system 100 can configure the video LDM according to a selected frame rate (e.g., from 4 frames per second, 8 frames per second, 12 frames per second), and can generate renderings 132 according to the selected frame rate to provide the renderings 132 to the video LDM. This can allow the system 100 to generate sufficiently long 4D animations as well as temporally smooth 4D animations.

The system 100 can include at least one updater 140. The updater 140 can configure (e.g., train, modify, update, etc.) the scene representation 124 and/or the motion generator 128 or one or more components thereof based at least on one or more metrics 136 generated by the models 112 or based on outputs (e.g., estimated outputs) from the models 112. In some implementations, the models 112 are frozen (e.g., do not have their parameters, such as weights and/or biases, changed) during operation of the updater 140 to update the at least one of the scene representation 124 or the motion generator 128. In some implementations, the updater 140 can configure the models 112 according to the data 106, 108 input to a given model 112 and an estimated output generated by the given model 112 responsive to the input data (e.g., to perform various diffusion model training operations, latent diffusion model training operations, conditioning of the models 112, classifier/classifier-free guidance training of models 112, etc.).

For example, the updater 140 can use various objective functions, such as cost functions, scoring functions, and/or gradient functions, to evaluate estimated (e.g., candidate) outputs that the models 112 determine (e.g., generate, produce) in response to receiving the renderings 132 as input. The updater 140 can update the model 112 responsive to the output of the objective function, such as to modify the model 112 responsive to whether a comparison between the estimated outputs and the corresponding data satisfies various convergence criteria (e.g., an output of the objective function is less than a threshold output or does not change more than a predetermined value over a number of iterations; a threshold number of iterations of training is completed; the model 112 satisfies performance criteria (e.g., with respect to output quality, accuracy of a downstream classifier operating on the output of the model 112, etc.)). The objective function can include, for example and without limitation, a least squares function, an L1 norm, or an L2 norm.

Referring further to FIG. 1, in some implementations, one or more models 112 can generate a metric 136 responsive to (processing of) the one or more renderings 132. The models 112 can perform a score distillation process (e.g., and without limitation, score distillation sampling (SDS), variational score distillation) to determine the metric 136. The models 112 can receive a given rendering 132 as input, diffuse (e.g., apply noise to in accordance with parameters of the models 112) the input to generate a diffused rendering z, and determine the metric 136 based at least on the diffused rendering z, such as to determine a gradient based at least on the diffused rendering z. The system 100 can determine the metric 136 to include a gradient of a scoring function, such as a Kullback-Leibler divergence (KLD), for one or more models 112.

For example, to determine the metric 136 to include a gradient for updating the scene representation 124 (e.g., to update the parameters θ of the function g(θ)), the system 100 can use respective scoring functions of at least one of the text-to-image model 112 or the multiview diffusion model 112 (which can each score the diffused rendering 132 input to the respective model 112 relative to an output of the respective model 112 conditioned according to the input 120) as the function for which the gradient for the metric 136 is determined. The use of both the text-to-image model 112 and multiview diffusion model 112 can allow for enforcement of quality of the renderings 132. To determine the metric 136 to include a gradient for updating motion predicted by the motion generator 128 (e.g., to update the parameters of the MLP for the deformation field (D), the system 100 can use respective scoring functions of at least one of the text-to-image model 112 or the text-to-video model 112 (which can each score the diffused rendering 132 input to the respective model 112 relative to an output of the respective model 112 conditioned according to the input 120).

For example, the system 100 can determine the gradient of the metric 136 as at least one of a score distillation sampling (SDS) loss or a variational score distillation (VSD) loss. As such, the system 100 can use the metric 136 to facilitate ensuring that the renderings 132 from the scene representation 124 have a high likelihood under the prior defined by any one or more models 112 used for the scoring. The metric 136 can include or have various terms applied to incorporate specific functions into how the updater 140 updates at least one of the scene representation 124 or the motion generator 128, such as weights or scaling factors corresponding to functions such as motion amplification, view guidance, negative prompting, and/or physics model-based validation; such terms can be configurable in value to control the effects of these functions.

The updater 140 can update at least one of the scene representation 124 or the motion generator 128 based at least on the respective metrics 136 (e.g., based at least on the gradient of the scoring functions of the text-to image model 112 and the multiview diffusion model 112 for updating the scene representation 124; based at least on the gradient of the scoring functions of the text-to-image model 112 and the text-to-video model 112 for updating the motion generator 128). For example, the updater 140 can provide an update 144 to backpropagate respective gradients into the scene representation 124 and/or motion generator 128, such as to update parameters θ and/or update deformation field Φ. For example, the updater 140 can modify the parameters θ and/or deformation field Φ using various optimization algorithms, including but not limited to gradient descent, according to the respective gradients.

Referring further to FIG. 1, the system 100 can perform autoregressive generation of 4D content, such as to extend the length (e.g., number of frames) of the 4D content. For example, the system 100 can select a first frame of a second time point (e.g., subsequent to a first, initial time point) of a first sequence of a plurality of frames of the scene representation 124 and motion generator 128, such as a middle frame of the first sequence. The system 100 can use the first frame as an initial frame of the scene representation 124 of a second sequence of frames, and update a second motion generator 128 (e.g., second deformation field) based at least on the first frame, such as to allow the second motion generator 128 to be used to render third frames at third time points subsequent to the second time point. In some implementations, the system 100 interpolates (e.g., using a weighting function) between overlapping portions of the frames of the first and second sequences. The system 100 can perform such autoregressive operations iteratively to chain together multiple sequences of frames.

In some implementations, the system 100 performs amplification of motion of the objects represented by the 4D representation. For example, the system 100 can apply a scaling factor to the metric 136 (or a parameter corresponding to the metric, such as a component determined by the video diffusion model 112 used to determine the gradient for a given frame i or used to determine the metric 136) to amplify motion. The system 100 can control the value of the scaling factor; for example, a value of 1 can correspond to no scaling, while a value greater than one can increase motion for the given frame i. In some implementations, the system 100 determines the scaled metric 136 for the given frame i based at least on the metric 136, the scaling factor, and an average of the metrics 136 for the frames of the 4D representation.

The system 100 can implement negative prompt guidance for configuration of at least one of the scene representation 124 or the motion generator 128. For example, the system 100 can apply, as input to one or more models 112 (e.g., during configuration of the motion generator 128 (as well as the scene representation 124)), one or more negative prompts indicative of restrictions on motion (e.g., “low motion,” “static statue,” “not moving,” “no motion”). This can be performed in a manner analogous to classifier-free guidance to allow the 4D representation to have more dynamic and vivid scenes.

In some implementations, the system 100 includes or is coupled with a physics model, such as a model indicative of expected motion of objects. The system 100 can use the physics model to evaluate the poses and/or motion of objects represented by the scene representation 124. For example, the system 100 can provide one or more renderings 132 from the scene representation 124 as input to the physics model to generate an expected motion from the physics model, and compare the expected motion with actual motion between the one or more renderings 132 and a second rendering 132 to perform the evaluation. The system 100 can update the scene representation 124 based at least on the evaluation, such as to modify the scene representation 124 to reduce the difference between the expected motion and actual motion.

In some implementations, the system 100 uses the scene representation 124 to extract 3D assets from the scene representation 124. For example, the system 100 can perform any of various image processing operations (e.g., segmentation, feature detection, etc.) on one or more renderings 132 to retrieve assets such as joints, movements, and/or deformations.

Now referring to FIG. 2, FIG. 2 depicts an example computing environment including a system 200, in accordance with some embodiments of the present disclosure. The system 200 can be used to perform text-to-4D operations with high quality outputs. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 200 can include any function, model (e.g., machine learning model), operation, routine, logic, or instructions to perform functions such as configuring, deploying, updating, and/or generating outputs from machine learning models, including text-to-video model 216 and text-to-image model 220, as described herein. The system 200 can incorporate features of the system 100, such as to facilitate periodic updating or modifications of content model 204 using updater 140. The system 200 can be implemented at least partially by the same or different entities or devices that implement the system 100.

The system 200 can include at least one content model 204. The content model 204 can incorporate features of at least one of the scene representation 124 or the motion generator 128 described with reference to FIG. 1. For example, the content model 204 can include a 3D object and/or scene representation, such as one or more 3D Gaussians and/or a NeRF, coupled with a deformation field (e.g., as represented by an MLP). As described with reference to FIG. 2, the system 200 can be used to update the deformation field subsequent to configuration of the scene representation; the system 200 can similarly be used to perform the configuration of the scene representation (e.g., using the multiview diffusion model 112 to generate gradients for scoring of renderings 132 of multiple different views from 3D Gaussian and/or NeRF representations of 3D objects and/or 3D scenes, allowing the system 200 to generate a static 3D Gaussian representative of prompt 210).

The system 200 can receive one or more prompts 210. The prompts 210 can indicate one or more features of a 4D representation for the system 200 to generate, such as one or more features of one or more views of the content model 204. The prompts 210 can be received from one or more user input devices that may be coupled with the system 200. The prompts 210 can include any of a variety of data formats, including but not limited to text, speech, audio, image, or video data indicating instructions corresponding to the features of the 4D representation for the system 200 to generate. The prompts 210 can indicate, for example and without limitation, information regarding classes and/or characteristics of objects to be represented by the 4D representation. In some implementations, the system 200 presents a prompt requesting the one or more features via a user interface, and receives the prompts 210 from the user interface. The prompts 210 can be received as semantic information (e.g., text, voice, speech, etc.) and/or image information (e.g., input indicative of pixels indicating regions in the scene).

As noted above, the system 200 can initialize the 4D representation of the content model 204 using a static 3D scene first generated based at least on the prompt 210. Subsequently, the system 200 can render, from the content model 204, a plurality of frames 208. The frames 208 can be 2D image frames having respective camera poses cᵢ (e.g., c₁, c₂, c₃, and c₄), and respective time steps τᵢ(e.g., τ₂, τ₂, τ₃, τ₄). As such, each frame 208 can correspond to a given camera pose and time step of the 4D representation of the content model 204.

In addition to rendering the frames 208, the system 200 can render, from the content model 204, at least one frame 212. The frame 212 can have at least one of a camera pose or time step different from one or more of the frames 208. For example, as depicted in FIG. 2, the frame 212 is rendered for time step τ₄ and from a random camera pose 64. In some implementations, a subset of the frames 212 are rendered from the same camera pose as the frames 208, and at least one other frame 212 is rendered from a different camera pose than the camera poses of the frames 208.

The system 200 can diffuse (e.g., add noise to using the forward diffusion process of models 112) the frames 208 and the frame(s) 212. Responsive to diffusing the frames 208 and/or the frame(s) 212, the system 200 can provide the (diffused) frames 208 as input to a text-to-video model 216, such as to a denoising network 116 of the text-to-video model 216. The text-to-video model 216 can include, for example, the denoising network 116 and the one or more temporal layers 118 of the video diffusion model 112. In some implementations, the system 200 inputs the diffused frames 208 to the denoising network 116 through the encoder 114, such as to perform scoring/gradient determination operations in the latent space of the denoising network 116 and temporal layers 118 (and can similarly input diffused frames 212 to a corresponding denoising network 116 of a text-to-image diffusion model through a corresponding encoder 114 of the text-to-image diffusion model).

Responsive to receiving the inputted frames 208, the text-to-video model 216 can be used to generate a gradient (e.g., as described for metric 136 of FIG. 1) for a score of the inputted frames 208 with respect to the parameters (e.g., parameters (D) of the content model 204. The updater 140 can update the content model 204 according to the gradient, such as to perform an optimization (e.g., and without limitation, gradient descent) to modify the parameters of the content model 204 until a convergence condition is achieved. The system 200 can iteratively perform rendering of frames 204, 208, generation of gradients using the models 216, 220, and updating of the content model 204 (e.g., by backpropagation of the gradients into the content model 204) until the convergence condition is achieved.

Responsive to diffusing the frames 212, the system 200 can provide the (diffused) frames 212 as input to a text-to-image model 220, such as to a denoising network 116 of the text-to-image model 220. The text-to-image model 220 can include, for example, the diffusion model described with reference to denoising network 116 of FIG. 1 (e.g., a denoising network configured to generate images from text). Responsive to receiving the inputted frames 212, the text-to-image model 220 can be used to generate a gradient (e.g., as described for metric 136 of FIG. 1) for a score of the inputted frames 212 with respect to the parameters (e.g., parameters (D) of the content model 204. In some implementations, the system 200 determines a combined gradient responsive to processing of frames 208 by the text-to-video model 216 and processing of frames 212 by the text-to-image model 220, and the updater 140 can update the content model 204 according to the combined gradient. As such, the system 200 can use the text-to-video model 216 to allow the content model 204 to have realistic dynamics (e.g., motion) for the 4D content, and can use the text-to-image model 220 to allow the content model 204 to render frames 204 having realistic, high quality representations of the 3D scenes at each time step with respect to the prompt 210.

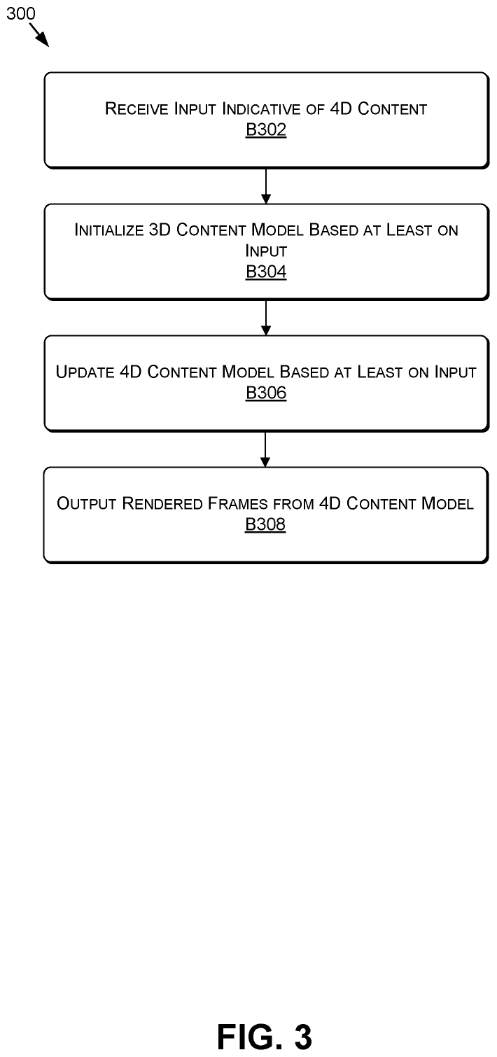

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the systems of FIG. 1 and FIG. 2. However, this method may additionally or alternatively be executed by any one system, or any combination of systems, including, but not limited to, those described herein.

FIG. 3 is a flow diagram showing a method 300 for generating 4D content, in accordance with some embodiments of the present disclosure. Various operations of the method 300 can be implemented by the same or different devices or entities at various points in time. For example, one or more first devices may implement operations relating to configuring diffusion machine learning models, one or more second devices may implement operations relating to configuring 4D content models, and one or more third devices may implement operations relating to receive user inputs requesting content to be generated by the diffusion machine learning models and/or the 4D content models and presenting or otherwise providing the content. The one or more third devices may maintain the neural network models, or may access the neural network models using, for example and without limitation, APIs provided by the one or more first devices and/or the one or more second devices.

The method 300, at block B302, includes receiving input indicative of 4D content to be generated. The 4D content can be for a sequence of frames of 3D content data, which can be arranged to have realistic motion of object(s) represented by the 3D content data across space and time. The input can include any one or more of text, audio, speech, image, or video data, such as to be received as a prompt, e.g., via a conversational interface. The input can include one or more images of a subject to be represented by the 4D content, such as a user or other person to allow for personalization of the 4D content.

The method 300, at block B304, can include initializing a 3D content model based at least on the input. The 3D content model can include at least one of a 3D Gaussian model (e.g., 3D Gaussian Splatting), a NeRF, a point cloud, or HexPlanes. The 3D content model can be initialized by iteratively rendering frames, for multiple different camera poses, from the 3D content model, evaluating the rendered frames using a machine learning model, and updating the 3D content model according to the evaluation until a convergence condition is satisfied. The machine learning model can include at least one of a multiview diffusion model or a text-to-image diffusion model, such that the evaluation can provide a metric (e.g., output of scoring function; gradient) for the renderings relative to parameters of the 3D content model. The 3D content model can be updated (e.g., and without limitation, using gradient descent) according to the metric. In some implementations, the metric includes a component for camera pose conditioning and/or trajectory conditioning.

The method 300, at block B306, can include updating a 4D content model based at least on the input. The 4D content model can include the 3D content model and a motion generator, such as a dynamics model. For example, the motion generator can include a machine learning model, such as an MLP, that can be configured to generate motion of features of objects represented by the 3D content model between frames rendered based on the 3D content model. For example, a plurality of frames can be rendered from the 3D content model (e.g., from the 3D Gaussian, etc.). The rendered frames can include one or more first frames having predetermined camera poses, and one or more second frames that may have the second poses as the first frames and/or different pose(s), such as randomly selected poses. The rendered frames can be provided as input to at least one of a text-to-image model (which can be the same model as used for the initialization of the 3D content model) or a text-to-video model. The text-to-video model can be a diffusion model, such as a latent diffusion model that has been fined-tuned and/or had transfer learning performed to have temporal layers incorporated in the diffusion model. The at least one of the text-to-image model or the text-to-video model can evaluate the rendered frames, such as to be used to generate gradients of the data of the rendered frames relative to parameters of the motion generator. The motion generator can be updated based on the gradients, such as to have the gradients backpropagated through the configuration of the motion generator until a convergence/threshold criteria is satisfied. In some implementations, a physics model is used to evaluate the rendered frames. The motion generator can be updated according to one or more metrics such as view guidance, regularization, motion amplification, and/or negative prompting.

The method 300, at block B308, includes outputting rendered frames from the updated 4D content model. For example, this can include causing at least one of (i) a simulation to be performed using the rendered frames from the updated 4D content model or (ii), presentation of the rendered frames using a display. In some implementations, the rendered frames are processed to detect 3D assets, such as joints, movements, or deformations of object(s) represented by the 4D content model. In some implementations, 4D content is generated auto-regressively, such as by using a first frame from a first instance of configuration of the 4D content model as input for configuration of a second instance of the 4D content model.

### Example Content Streaming System

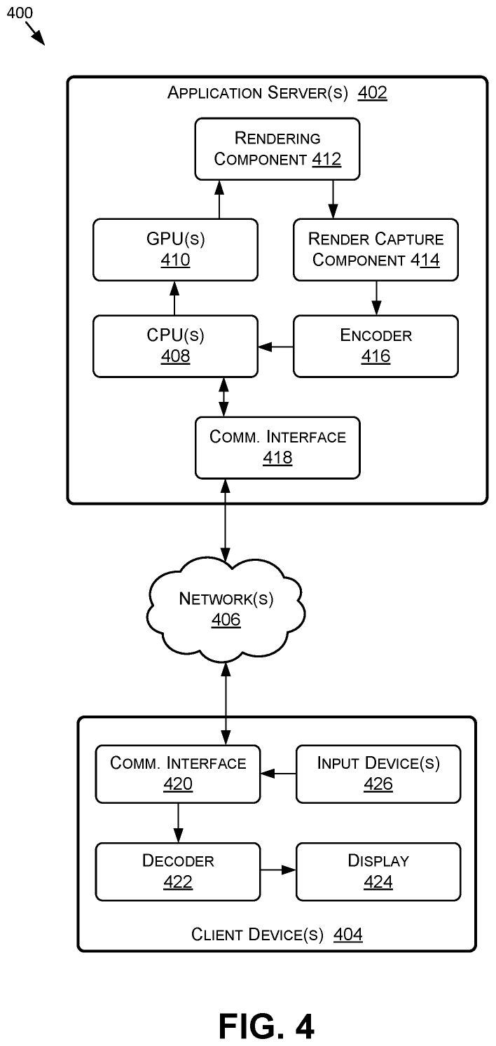

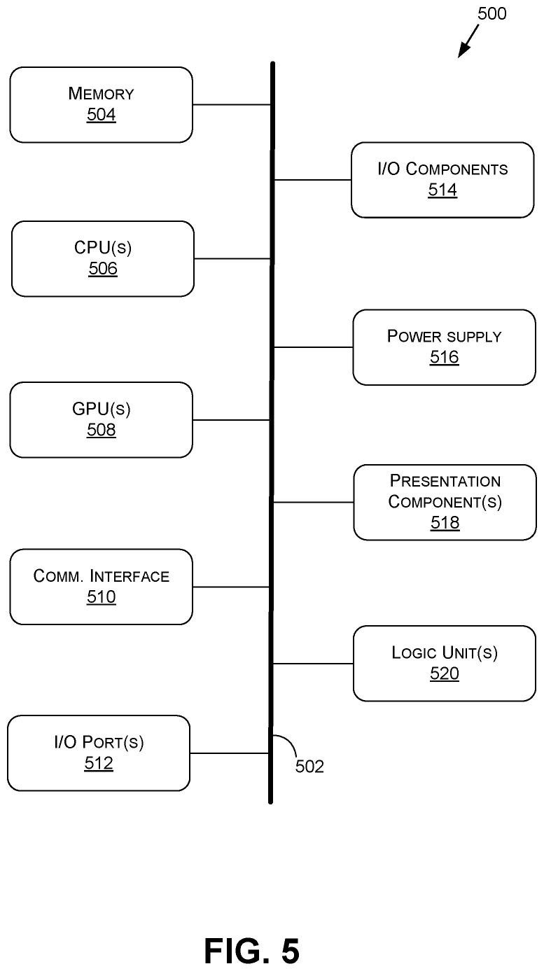

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to perform diffusion model and NeRF training and runtime operations. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations including display or simulation operations.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as to provide prompts as input for generation of 4D content. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc. —may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to generate a prompt, image data 106, and/or video data 108. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

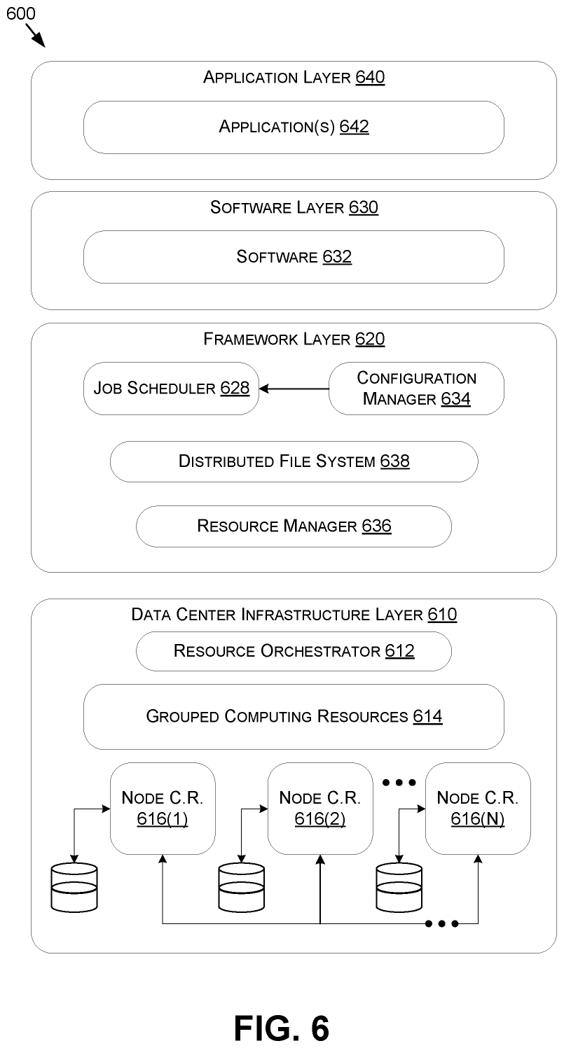

FIG. 6 illustrates an example data center 600 that may be used in at least one embodiments of the present disclosure, such as to implement the system 100 and/or the system 200 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 112.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train machine learning models 112) or predict or infer information using one or more machine learning models (e.g., to generate scene representation 124, motion generator 128, and/or content model 204) according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
receive an input indicating one or more features of content, the content comprising at least one of an object or a scene;
initialize a content model, according to the input, to represent the input in three spatial dimensions and a time dimension;
update the content model by rendering one or more sequences of frames from the content model, determining, using a latent diffusion model, a metric of the one or more sequences, and modifying the content model according to the metric, until a convergence condition is satisfied; and
cause at least one of (i) a simulation to be performed using the updated content model or (ii) presentation of the updated content model using a display.

2. The processor of claim 1, wherein the latent diffusion model comprises one or more layers configured for the time dimension, and comprises or is coupled with an optimizer to determine the metric based at least on a gradient associated with a given frame of the one or more sequences of frames.

3. The processor of claim 1, wherein the content model is conditioned on camera movements relating to the three spatial dimensions and a time value relating to the time dimension, and the one or more circuits are to render a given sequence of frames of the one or more sequences of frames according to a given camera pose for the given sequence of frames and to provide the given sequence of frames as input to the latent diffusion model.

4. The processor of claim 1, wherein the one or more circuits are to:
update the content model according to a predetermined input identifying a camera pose for the given sequence of frames and a time point for one or more frames of the given sequence of frames; and
determine the metric according to the given sequence of frames rendered according to the predetermined input.

5. The processor of claim 1, wherein the content model comprises:
a deformation field to represent motion in the one or more sequences of frames; and
at least one of a Gaussian splatting representation, a neural radiance field (NeRF), a mesh representation, or a point cloud.

6. The processor of claim 1, wherein the one or more circuits are to:
render, from the updated content model, a first frame for a first time point and a second frame for a second time point subsequent to the first time point;
modify the updated content model according to the second frame; and
render, from the modified content model, a third frame for a third time point subsequent to the second time point according to the second frame.

7. The processor of claim 1, wherein the input comprises natural language data and one or more images, and the one or more circuits are to update the content model according to the one or more images.

8. The processor of claim 1, wherein the one or more circuits are to update the content model according to a physics model to measure a physics-based realism of motion represented in the one or more sequences of frames.

9. The processor of claim 1, wherein the one or more circuits are to identify, from the updated content model, at least one of a joint of an object represented by the updated content model, a movement property of the object, or a deformation property of the object.

10. The processor of claim 1, wherein the processor is comprised in at least one of:
a system for generating synthetic data;
a system for performing simulation operations;
a system for performing conversational AI operations;
a system for performing collaborative content creation for 3D assets;
a system comprising one or more large language models (LLMs);
a system for performing digital twin operations;
a system for performing light transport simulation;
a system for performing deep learning operations;
a system implemented using an edge device;
a system implemented using a robot;
a control system for an autonomous or semi-autonomous machine;
a perception system for an autonomous or semi-autonomous machine;
a system incorporating one or more virtual machines (VMs);
a system implemented at least partially in a data center; or
a system implemented at least partially using cloud computing resources.

11. A system comprising:
one or more processing units to execute operations comprising:
receiving an input indicating one or more features of content, the content comprising at least one of an object or a scene;
initializing a content model, according to the input, to represent the input in three spatial dimensions and a time dimension;
updating the content model by rendering one or more sequences of frames from the content model, determining, using a latent diffusion model, a metric of the one or more sequences, and modifying the content model according to the metric, until a convergence condition is satisfied; and
causing at least one of (i) a simulation to be performed using the updated content model or (ii) presentation of the updated content model using a display.

12. The system of claim 11, wherein the latent diffusion model comprises one or more layers configured for the time dimension, and comprises or is coupled with an optimizer to determine the metric based at least on a gradient associated with a given frame of the one or more sequences of frames.

13. The system of claim 11, wherein the content model is conditioned on camera movements relating to the three spatial dimensions and a time value relating to the time dimension, and the one or more processing units are to execute operations comprising rendering a given sequence of frames of the one or more sequences of frames according to a given camera pose for the given sequence of frames and to provide the given sequence of frames as input to the latent diffusion model.

14. The system of claim 11, wherein the one or more processing units are to execute operations comprising:
updating the content model according to a predetermined input identifying a camera pose for the given sequence of frames and a time point for one or more frames of the given sequence of frames; and
determining the metric according to the given sequence of frames rendered according to the predetermined input.

15. The system of claim 11, wherein the content model comprises:
a deformation field; and
at least one of a Gaussian splatting representation, a neural radiance field (NeRF), a mesh representation, or a point cloud.

16. The system of claim 11, wherein the one or more processing units are to execute operations comprising:
rendering, from the updated content model, a first frame for a first time point and a second frame for a second time point subsequent to the first time point;
modifying the updated content model according to the second frame; and
rendering, from the modified content model, a third frame for a third time point subsequent to the second time point according to the second frame.

17. The system of claim 11, wherein the input comprises natural language data and one or more images, and the one or more circuits are to execute operations comprising updating the content model according to the one or more images.

18. The system of claim 11, wherein the system is comprised in at least one of:
a system for generating synthetic data;
a system for performing simulation operations;
a system for performing conversational AI operations;
a system for performing collaborative content creation for 3D assets;
a system comprising one or more large language models (LLMs);
a system for performing digital twin operations;
a system for performing light transport simulation;
a system for performing deep learning operations;
a system implemented using an edge device;
a system implemented using a robot;
a control system for an autonomous or semi-autonomous machine;
a perception system for an autonomous or semi-autonomous machine;
a system incorporating one or more virtual machines (VMs);
a system implemented at least partially in a data center; or
a system implemented at least partially using cloud computing resources.

19. A method, comprising:
receiving, by one or more processors, an input indicative of at least one of an object or a scene;
initializing, by the one or more processors, based at least on the input, a plurality of spatial dimensions of a content model of the at least one of the object or the scene;
updating, by the one or more processors, the content model to have a temporal dimension responsive to evaluating a plurality of frames rendered from the content model at a plurality of points in time using a latent diffusion model having one or more temporal layers, to generate an updated content model; and
outputting, by the one or more processors, one or more frames from the updated content model.

20. The method of claim 19, wherein the content model comprises a 3D Gaussian splatting representation corresponding to the plurality of spatial dimensions coupled with a multilayer perceptron (MLP) corresponding to the temporal dimension.
